(19) United States
(12) Patent Application Publication
(10) Pub. No.: US 2006/0126446 A1
(43) Pub. Date: Jun. 15, 2006

(54) Watch assembly of a type with the housing arranged on the back of the hand

(76) Inventors: Pepijn Martens, Gent (BE); Irwin Wouts, Marcq en Baroeul (FR); Sebastien Druvent, Wattignies (FR)

Correspondence Address: KENYON & KENYON LLP, 1500 K STREET N.W., SUITE 700, WASHINGTON, DC, 20005, US

(21) Appl. No.: 10/541,208

(22) PCT Filed: Dec. 23, 2003
(86) PCT No.: PCT/FR03/03885

§ 371 Date: Nov. 21, 2005

(30) Foreign Application Priority Data
Jan. 8, 2003 (FR) 03/00144

(51) Int. Cl. G04B 37/00

(52) U.S. Cl. 368/282

(57) ABSTRACT

The watch assembly comprises a case housing the watch mechanism and the display screen, actuator means for actuating the mechanism external to the case and connected to the mechanism by connection means, and a wristlet supporting the actuator means, the connection means, and the case, which case is placed on the back of the hand. The wristlet comprises a flexible piece comprising: a) a proximal portion for surrounding the wrist; b) a distal portion for surrounding at least the first phalanx at the base of the index finger; and c) an intermediate portion for extending over the back of the hand between said proximal and distal portions and supporting the case. At least one actuator means is mounted laterally on the distal portion of the wristlet so as to be actuatable by the thumb of the same hand.

The present invention relates to the field of watches, where this term is used broadly, including stop watches, chronometers, etc. More particularly, the invention relates to a watch assembly for timing sports, with the controls offset in such a manner as to enable them to be actuated with one hand only.

In conventional manner, a watch assembly comprises a case housing the watch mechanism proper and a wristlet supporting the case and serving to hold it on the wrist of a user. When the user is wearing a pullover, a jacket, a shirt, or more generally any long-sleeved garment, it is often necessary for the user to push back the sleeve in order to consult the display screen of the watch or indeed to have access to controls for actuating the mechanism of the watch.

In addition, another drawback of conventional watch assemblies is of concern to people engaging in a sports activity, such as runners, cyclists, or even skiers. This drawback is associated with the fact that the means for actuating the watch mechanism are located directly on the watch case in such a manner that the user must necessarily use the other hand, i.e. the hand not wearing the watch, in order to operate the desired controls. Such an operation is likely to interfere with smooth performance of the sport in question, and can even lead to accidents insofar as it momentarily distracts the attention of the athlete.

In order to mitigate those two drawbacks, proposals have already been made for a watch assembly in which the case is worn beyond the wrist on the back of the hand, and in which the means for actuating the watch mechanism are offset relative to the wrist, being located towards the end of the middle, ring, or little finger so as to be suitable for being actuated by using the thumb of the same hand. Such a watch assembly is known from U.S. Pat. No. 4,652,141.

In that document, the wristlet supporting the case and also the actuator means and the associated connection means connecting the actuator means to the watch mechanism is constituted by a glove or the like covering the entire palm of the hand, the back of the hand, and at least the entire middle and ring fingers together with the zone between the index finger and the thumb. In a particular embodiment, shown in FIG. 11, provision is even made for an element supporting the watch, the actuator means, and the connection means that is superposed on a glove so as to be capable of being fastened releasably thereto. Under such circumstances, there are therefore two thicknesses of material covering the middle and ring fingers.

The watch assembly disclosed by U.S. Pat. No. 4,652,141 presents various drawbacks. It is uncomfortable for the user, in particular when engaging in sports in which it is not usual to wear gloves. The presence of actuator means at the ends of the middle, ring, and possibly also little fingers can lead to wrong operations as a result of the normal movements made by the hand when performing a sport, in particular by the ring or little finger pressing against the middle or ring finger, respectively.

The object of the present invention is to mitigate the above-mentioned drawbacks by proposing a watch assembly which, in conventional manner, comprises a case housing the watch mechanism and the display screen, actuator means for actuating the mechanism external to the case and connected to the mechanism by connection means, and a wristlet supporting the actuator means, the connection means, and the case, the case being placed on the back of the hand.

In a manner that is characteristic of the present invention, the wristlet comprises a flexible piece comprising:

a) a proximal portion for surrounding the wrist;

b) a distal portion for surrounding at least the first phalanx at the base of the index finger; and

c) an intermediate portion for extending over the back of the hand between said proximal and distal portions and supporting the case; in addition at least one actuator means is mounted laterally on the distal portion of the wristlet so as to be actuatable by the thumb of the same hand.

Because of this particular arrangement, the inconvenience due to the wristlet is very small. In addition, since the actuator means is situated on the thumb side of the index finger, there is no risk of untimely actuation due to two fingers pressing against each other, since the thumb is naturally spaced well apart from the other digits.

In a variant embodiment, the distal portion of the wristlet is configured to surround solely the proximal phalanx and possibly also the middle phalanx of the index finger. The end of the index finger is thus quite free.

In a variant embodiment, two distinct actuator elements are mounted laterally and longitudinally on the distal portion of the wristlet. For example, these might comprise a first actuator element for ON/OFF control and a second actuator element for intermediate time control.

In a variant embodiment, two distinct actuator elements are mounted transversely on the distal portion of the wristlet. For example, these might comprise a first element disposed on the side of the index finger serving to actuate an ON/OFF control, and a second element disposed beside the first, e.g. on top of the index finger, serving to actuate an intermediate time control.

Preferably, the actuator means and the connection means are flexible. Thus, the presence of said means does not lead to discomfort for the wearer.

In a variant embodiment, the flexible piece from which the wristlet is made comprises at least locally a layer of flexible material, in particular elastomer material, in which the connection means and the actuator means are integrated.

Under such circumstances, in a variant embodiment, the actuator means are constituted by a powder that is locally mixed in the layer of flexible material and that presents electrical resistance that varies as a function of the pressure exerted thereon.

In a variant embodiment, the actuator elements are formed by silkscreen printing on the wristlet.

The connection means may be constituted by metal tracks or wires or threads embedded in the layer of flexible material, or possibly hidden at least in part in an element for finishing the side of the wristlet.

In a variant embodiment the case is oval in shape with its major axis extending in the longitudinal direction of the hand, the two opposite sides of the intermediate portion closely tracking the oval configuration. This produces a wristlet that is particularly compact over the width of the hand, while preserving sufficient readability for the information carried on the display screen, where the display extends in the long direction of the case.

In a variant embodiment, the wristlet further includes an opening in the intermediate portion, giving access to the back face of the case. This enables the battery in the case to be changed, if necessary.

In a variant embodiment, at least one actuator means is mounted on the intermediate portion of the wristlet, at a distance from the case.

In a variant embodiment, at least one actuator means is mounted on the display screen.

The present invention can be better understood on reading the following description of two embodiments of a watch assembly having offset controls, the embodiments being given as non-exhaustive examples and being shown in the accompanying drawings, in which:

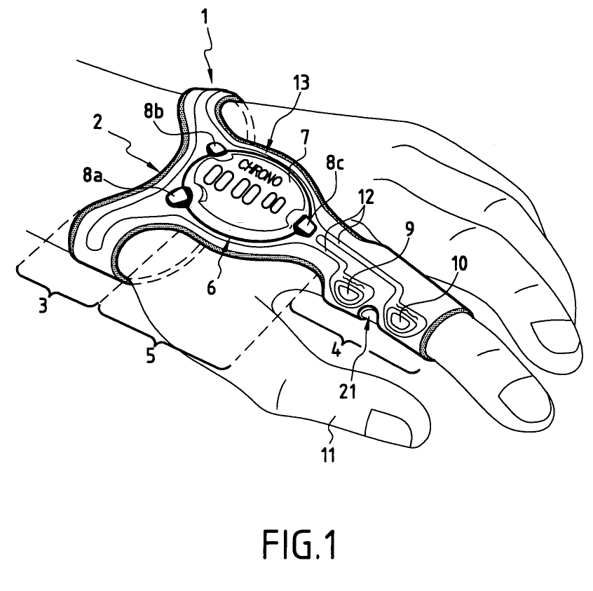

FIG. 1 is a diagrammatic perspective view of the first embodiment;

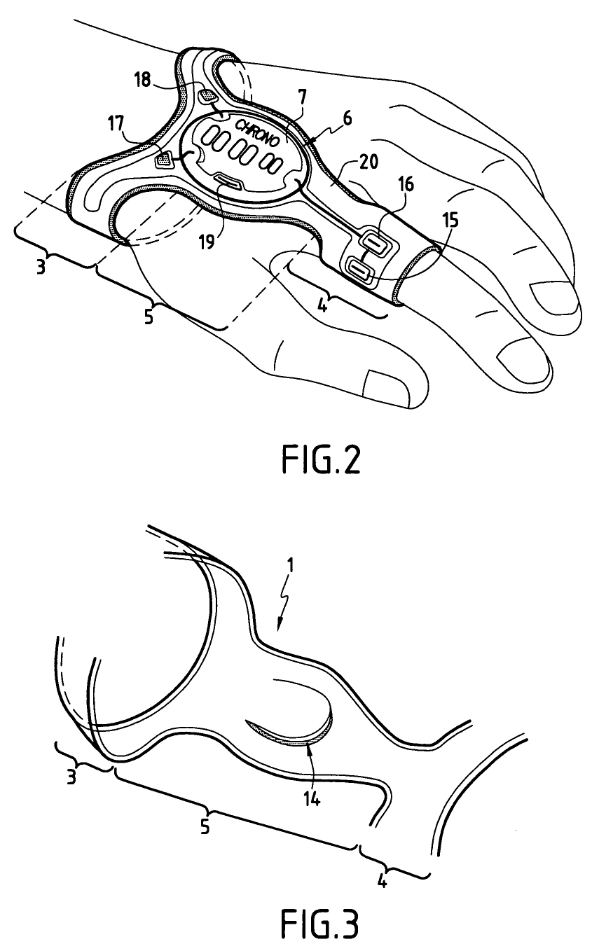

FIG. 2 is a fragmentary view of the underside of the first embodiment shown in FIG. 1; and

FIG. 3 is a diagrammatic perspective view of the second embodiment.

The watch assembly 1 of the present invention comprises in conventional manner a watch which is mounted, together with its actuator means, on a support wristlet.

In a manner that is less conventional but that is already known, some of the actuator means are offset away from the watch proper so as to be suitable for being actuated by the user using a single hand. In addition, the watch proper is mounted on the support wristlet in such a manner as to be positioned on the back of the hand, and not on the wrist.

The term “wristlet” in the present text should be understood broadly as being an element suitable for supporting a watch.

As shown in FIG. 1, the support wristlet 2 of the present invention comprises three portions presenting quite distinct functions: a proximal portion 3; a distal portion 4; and an intermediate portion 5 interconnecting the proximal and distal portions 3 and 4.

The proximal portion 3 is similar to a traditional wristlet for a watch in that it surrounds the user's wrist and serves to hold the watch assembly 1 to said wrist. However, and this difference is essential, this proximal portion 3 does not itself carry the watch 2, which is supported by the intermediate portion 5.

The proximal portion 3 can be secured to the wrist using any suitable already-known means. In particular, the proximal portion may be in the form of a closed tube, that is elastic in part so as to enable it to be put on the wrist. Above all, it may be an open strap, having fastener means that face each other at two opposite free ends, which means may be of the buckle type or of the self-fastening type with hooks and loops.

The distal portion 4 is intended to surround at least the base of the index finger, preferably its proximal phalanx and possibly also its middle phalanx. It is in the form of a generally closed tube suitable for being easily engaged on the index finger. It may optionally be open with fastener means between its two free ends, in particular using a self-fastening mechanical closure system based on hooks and loops.

In the first embodiment shown in FIG. 1, the distal portion 4 covers the proximal phalanx and also a portion of the middle phalanx. In order to limit any inconvenience at the joint between the proximal and middle phalanges, a transverse cutout 21 is provided in the distal portion 4 in the zone that is immediately in register with said joint.

The intermediate portion 5 connects the proximal portion 3 to the distal portion 4, and in so doing covers a limited fraction of the back of the hand.

The case 6 containing the mechanism of the watch and its display screen 7 is mounted on the wristlet 2, specifically on its intermediate portion 5. This can be achieved by any suitable means, either by adhesive, or using mechanical means, etc.

In the example shown, the watch mechanism has five distinct actuator elements, three of the elements 8a, 8b, and 8c being associated directly with the case 6, and two of the elements 9 and 10 being offset from the case 6 and disposed laterally on the distal portion 4 of the wristlet 2. More precisely, the first offset actuator element 9 overlies the proximal phalanx while the second offset element 10 overlies the middle phalanx. They are thus disposed in the same longitudinal direction and are on the side of the wristlet so as to be suitable for being actuated directly by the thumb 11.

The two offset actuator elements 9 and 10 are connected to the watch mechanism by connection means 12 which are integrated in the wristlet 2.

The wristlet 2 is a flexible piece that is generally light in weight and perforated, with the term “piece” being used broadly, it being understood that it may itself comprise an assembly of a plurality of flexible pieces that may be made of knitted, woven, or possibly non-woven textile materials, elastomer materials, leather, or other flexible materials. The composition of this piece may differ between its proximal, intermediate, and distal portions.

In a specific embodiment, the flexible piece for forming the wristlet is constituted by a fabric whose outside face, i.e. face that does not come into contact with the user's skin, is coated in a layer of elastomer, at least in the zone of the wristlet in which the connection means 12 and the offset actuator means 9 and 10 are situated. Under such circumstances, the metal tracks constituting the connection means 12 are situated within the elastomer layer. A conductive powder of electrical resistance that varies as a function of the pressure exerted thereon is also mixed in with this elastomer layer. It is this mixture of powder and elastomer that constitutes the actuator elements 9 and 10. This particular disposition presents the advantage of not leading to any extra thickness or unacceptable stiffness on the index finger, which could be awkward for a user engaged in a sport.

In the example shown, the intermediate portion 5 of the wristlet has no function other than supporting the case 6 and the three actuator elements 8a, 8b, and 8c. Its configuration is thus almost the same as that of the case, with small margins 13 projecting from either side thereof.

In the present example, the watch case 6 is oval in shape with its major axis extending substantially in the longitudinal direction of the hand. This oval shape enables the watch to be as compact as possible on the back of the hand in the transverse direction, while still providing the best possible legibility of the display screen 7 for the user. The intermediate portion 5 of the wristlet thus has opposite sides that are curved to track the sides of the oval shape of the case 6.

In the intermediate portion 5 of the wristlet 2 there may also be provided an opening 14 giving access to the back of the case 6, for example when such access is needed in order to change the battery in the watch.

In the second embodiment as shown in FIG. 3, the same references are used again for elements that are unchanged compared with the first embodiment described above. This second embodiment differs from the first mainly in the disposition and the structure of the actuator elements and the connection means. Two actuator elements 15 and 16 are disposed on the distal portion 4 of the wristlet 2, the first element 15 being disposed laterally, i.e. on the side of the index finger overlying the proximal phalanx, and the second element 16 is disposed beside the first element 15 on the back of the proximal phalanx. These two actuator elements in this second embodiment thus have a transverse disposition and not a longitudinal disposition as in the first embodiment. Actuating the second element placed on the back of the proximal phalanx requires special attention since the movement required is less natural. This helps avoid potential wrong moves. This second element is therefore given the less-frequent control to actuate, for example the start/reset control.

Two actuator elements 17 and 18 are disposed on the intermediate portion 5 or possibly on the proximal portion 3 of the wristlet 2 at a distance from the case 6. Like the first two elements 15 and 16, they are therefore offset relative to said case 6.

A last actuator element 19 is disposed on the display screen 7.

The first four actuator elements 15-18 are formed by silkscreen printing on the wristlet 2. In addition, the connection means connecting them to the watch mechanism are metal textile threads that may optionally be hidden in the facing 20, i.e. in the peripheral finishing element of the wristlet 2.

Thus, in the two embodiments described, both the connection means and the actuator elements are flexible and fully integrated in the wristlet, so that their presence does not impede the user in any significant manner while performing a sporting activity.

The present invention is not limited to the embodiment described above by way of non-exhaustive example. In particular, even though it is desirable to fit the distal portion with two actuator elements, e.g. of the ON/OFF type for the first element and of the intermediate time-taking type for the second element, the invention is not restricted thereto. There might be only one actuator element, or possibly three, providing at least one of these elements placed on the distal portion of the wristlet covering at least the base of the index finger is situated laterally in such a manner as to be directly accessible to the thumb of the same hand.

1. A watch assembly comprising a case housing the watch mechanism and the display screen, actuator means for actuating the mechanism external to the case and connected to the mechanism by connection means, and a wristlet supporting the actuator means, the connection means, and the case, the case being placed on the back of the hand, the assembly being characterized in that the wristlet comprises a flexible piece comprising:
a) a proximal portion (3) for surrounding the wrist;
b) a distal portion (4) for surrounding at least the first phalanx at the base of the index finger; and
c) an intermediate portion for extending over the back of the hand between said proximal and distal portions and supporting the case; and in that at least one actuator means is mounted laterally on the distal portion of the wristlet so as to be actuatable by the thumb of the same hand.

2. An assembly according to claim 1, wherein the distal portion of the wristlet is configured to surround only the proximal phalanx and possibly also the middle phalanx of the index finger.

3. An assembly according to claim 1 wherein two distinct actuator elements are mounted laterally and longitudinally on the distal portion of the wristlet, in particular an element for actuating an ON/OFF control, and an element for actuating an intermediate time control.

4. An assembly according to claim 1 wherein two distinct actuator elements are mounted transversely on the distal portion of the wristlet, and in particular a first element disposed on the side of the index finger serving to actuate an ON/OFF control, and a second element (16) disposed beside the first element, e.g. on the back of the index finger, serving to actuate an intermediate time control.

5. An assembly according to claim 1, wherein the actuator means and the connection means are flexible.

6. An assembly according to claim 1, wherein the flexible piece in which the wristlet is made comprises a layer of flexible material, in particular elastomer material, having the connection means and the actuator means integrated therein.

7. An assembly according to claim 6, wherein the actuator means are constituted by a powder which is locally mixed in the layer of flexible material and which presents electrical resistance that varies as a function of the pressure that is exerted thereon.

8. An assembly according to claim 5, wherein the actuator elements are formed by silkscreen printing on the wristlet.

9. An assembly according to claim 6, wherein the connection means are metal threads, wires, or tracks embedded in the layer of flexible material.

10. An assembly according to claim 5, wherein the connection means are metal textile threads, hidden at least in part in an element for finishing the side of the wristlet.

11. An assembly according to claim 1, wherein the case is oval in shape with its major axis extending in the longitudinal direction of the hand, the two opposite sides of the intermediate portion closely tracking the oval configuration.

12. An assembly according to claim 1, wherein the wristlet includes an opening in the intermediate portion giving access to the back face of the case.

13. An assembly according to claim 1, wherein the distal portion of the wristlet is designed to surround the proximal phalanx and the middle phalanx and includes a transverse cutout situated in register with the joint between the proximal and middle phalanges of the index finger.

14. An assembly according to claim 1, wherein at least one actuator element is disposed on the intermediate portion or the proximal portion of the wristlet, at a distance from the case.

15. An assembly according to claim 2, wherein two distinct actuator elements are mounted laterally and longitudinally on the distal portion of the wristlet, in particular an element for actuating an ON/OFF control, and an element for actuating an intermediate time control.

16. An assembly according to claim 2, wherein two distinct actuator elements are mounted transversely on the distal portion of the wristlet, and in particular a first element disposed on the side of the index finger serving to actuate an ON/OFF control, and a second element disposed beside the first element, e.g., on the back of the index finger, serving to actuate an intermediate time control.

17. An assembly according to claim 2, wherein the actuator means and the connection means are flexible.

18. An assembly according to claim 2, wherein the flexible piece in which the wristlet is made comprises a layer of flexible material, in particular elastomer material, having the connection means and the actuator means integrated therein.

19. An assembly according to claim 6, wherein the actuator means are constituted by a powder which is locally mixed in the layer of flexible material and which presents electrical resistance that varies as a function of the pressure that is exerted thereon.

20. An assembly according to claim 6, wherein the actuator elements are formed by silkscreen printing on the wristlet.
